(19) United States
(12) Patent Application Publication
(10) Pub. No.: US 2025/0047767 A1
(43) Pub. Date: Feb. 6, 2025

(54) CONVEYING A STATE OF AN ELECTRONIC DEVICE WHILE THE DISPLAY IS OFF

(71) Applicant: MOTOROLA MOBILITY LLC, WILMINGTON, DE (US)

(72) Inventors: AMIT KUMAR AGRAWAL, BANGALORE (IN); PANDURANGA REDDY PAILLA, NALGONDA (IN); VIJAYPRAKASH BHEEMSAINRAO, IDLUR (IN)

(21) Appl. No.: 18/364,341

(22) Filed: Aug. 2, 2023

(51) Int. Cl. H04M 1/02; H04M 1/72463

(52) U.S. Cl. CPC H04M 1/0235; H04M 1/0245; H04M 1/0268; H04M 1/72463

(57) ABSTRACT

A method provides techniques for adjusting a screen position of a moveable display on an electronic device, where the screen position is based on a device state. This enables a user to infer a device state, such as a current volume setting, battery charge level, or other setting, based on a position of the screen while the display is in an off state, enabling conveying of device state information without using any power. The method includes determining an idle state of the electronic device, determining a display state of the electronic device, and determining a device state of the electronic device. The method includes, in response to determining that the device is in an idle state and the display is in an off state, actuating the translation mechanism to translate the blade assembly to a position indicative of the device state of the electronic device.

### BACKGROUND

### 1. Technical Field

The present disclosure relates generally to portable electronic communication devices, and in particular to communication devices that have a single housing and a rollable flexible display that slides or translates.

### 2. Description of the Related Art

Smartphones have become an integral part of daily life, and provide a wide range of functionality. This functionality can include communication via voice calls, text messages, and/or other messaging applications (apps). Another important function of smartphones includes using multimedia applications. This use can include capturing photos and videos using onboard cameras, as well as listening to music and watching videos and movies. Other popular functions of smartphones include gaming, navigation, ecommerce, online banking, health and fitness tracking, and more. These are just a few examples, as smartphones offer a vast array of applications and functionalities that cater to various interests and needs.

As smartphones are so versatile, many users choose to take their smartphones everywhere they go. Therefore, power consumption for smartphones is of great importance. Power savings directly impact the battery life of a smartphone. Smartphones are heavily relied upon for various tasks throughout the day, such as communication, browsing, gaming, and multimedia consumption. By optimizing power consumption, users can enjoy longer battery life, ensuring their devices last throughout the day without needing frequent recharging. Thus, managing power consumption for smartphones is an important factor for maximizing battery life, ensuring portability and convenience, maintaining productivity and connectivity, reducing environmental impact, and enhancing the overall user experience.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 is a functional block diagram of a communication environment that includes a communication device configured to provide the features of the present disclosure, according to one or more embodiments;

FIG. 2A depicts a back view of an example communication device having a translating blade assembly with flexible display moved to a fully retracted sliding position where the blade assembly wraps around a back side of the housing of the communication device, according to one or more embodiments;

FIG. 2B depicts a front view of the example communication device of FIG. 2A with a front portion of the blade assembly not extending beyond the device housing, according to one or more embodiments;

FIG. 2C depicts a side view of the example communication device of FIG. 2A with the front portion of the blade assembly not extending beyond the device housing, according to one or more embodiments;

FIG. 3A depicts a front view of the example communication device having the translating blade assembly with the flexible display moved to the fully extended sliding position, where front-aligned portions of the flexible display are fully extended distally away from a device housing of the communication device, according to one or more embodiments;

FIG. 3B depicts a side view of an example communication device of FIG. 3A with the front portion of the blade assembly extending beyond the device housing, according to one or more embodiments;

FIG. 4A depicts a front view of the example communication device having the display in a fully retracted position, exposing an area on the front side of the device housing, according to one or more embodiments;

FIG. 4B depicts a front view of the example communication device of FIG. 4A with the display in a partially extended position such that a leading edge of the display appears flush with a top edge of the device housing, according to one or more embodiments;

FIG. 4C depicts a front view of the example communication device of FIG. 4A with the display in a partially extended position such that a leading edge of the display extends beyond a top edge of the device housing, according to one or more embodiments;

FIG. 4D depicts a front view of the example communication device of FIG. 4A with the display in a fully extended position such that a leading edge of the display extends further beyond a top edge of the device housing than as shown in FIG. 4C, according to one or more embodiments;

FIG. 5A depicts a front view of another example communication device having a laterally-extendable display that extends along a crosswise axis of the communication device and is in a fully retracted position, according to one or more embodiments;

FIG. 5B depicts a front view of the example communication device of FIG. 5A with the display in a partially extended position such that a leading edge of the display extends beyond a lateral edge of the device housing, according to one or more embodiments;

FIG. 5C depicts a front view of the example communication device of FIG. 5A with the display in a fully extended position such that a leading edge of the display extends further beyond a lateral edge of the device housing than as shown in FIG. 5B, according to one or more embodiments;

FIG. 6A depicts an exemplary user interface for configuration of various options for conveying a state of an electronic device while the display is off, according to one or more embodiments;

FIG. 6B depicts an exemplary user interface for configuration of advanced setup for conveying a state of an electronic device while the display is off, according to one or more embodiments; and

FIG. 7 is a flowchart presenting a method of conveying a state of an electronic device while the display is off, according to one or more embodiments.

### DETAILED DESCRIPTION

According to aspects of the present disclosure, an electronic device, a method, and a computer program product provides techniques for adjusting a screen position of a moveable display on an electronic device, where the screen position is based on a device state. The adjustment of the screen position enables a user to infer a device state, such as a current volume setting, battery charge level, or other setting, based on a position of the screen while the display is in an off state, enabling conveying of device state information without using any power for the display. The method includes determining an idle state of the electronic device, determining a display state of the electronic device, and determining a device state of the electronic device. The method includes, in response to determining that the device is in an idle state and the display is in an off state, actuating the translation mechanism to translate the blade assembly to a position indicative of the device state of the electronic device.

The present disclosure provides an effective technique for conserving power, and therefore extending battery life in an electronic device, such as a smartphone, that includes a rollable flexible display that slides or translates. During the course of a day, a user may place his/her smartphone (i.e., an electronic/communication device) on a table or desk during work or other activities. At various times throughout the day, a user may wish to obtain certain information about the smartphone. This information can include, but is not limited to, confirming a device setting, such as a device volume. The device volume state can include, but is not limited to, a ringer volume, a speaker volume, and/or a notification volume. Other device state information that can be conveyed to a user can include information such as battery charge level, network mode, and/or a new message status.

Disclosed embodiments utilize the position of the rollable flexible display that slides or translates in order to convey a state of an electronic device while the display is off. Disclosed embodiments provide an electronic device that includes a motorized, moveable electronic display. Based on a device state, a processor (controller) onboard the device moves the motorized, moveable electronic display to a given position, based on the device state. Accordingly, a user can obtain information about the device state without needing to touch the electronic display. Furthermore, the conveyance of the device state information does not consume any display power at the time of conveyance. That is, a user can simply observe the position of the display, and based on the position, can infer device state information. In this way, no battery power is consumed in order to convey the information, thereby serving to extend battery life for portable electronic devices such as smartphones. While examples described herein primarily refer to smartphones, disclosed embodiments may be applied to other portable electronic devices such as tablet computers, wearable computing devices, and/or other suitable computing devices.

In one or more embodiments, an electronic device is provided that includes a device housing, a blade assembly carrying a blade and a flexible display and slidably coupled to the device housing, a translation mechanism operable to slide the blade assembly in a plurality of positions relative to the device housing between an extended position and a retracted position, and a controller communicatively coupled to the blade assembly and the translation mechanism. The controller determines whether the electronic device is in an idle state with the flexible display being off. In response to determining that the electronic device is in the idle state, the controller: determines a device state of the electronic device; and actuates the translation mechanism to translate the blade assembly to place a leading edge of the flexible display in a position indicative of the device state of the electronic device.

In one or more embodiments, a method is provided. The method includes determining, by a controller of an electronic device, that the electronic device is in an idle state in which a display of the electronic device is off. The electronic device includes a device housing, a blade assembly carrying a blade and a flexible display and slidably coupled to the device housing, a translation mechanism operable to slide the blade assembly relative to the device housing to a plurality of positions between an extended position and a retracted position, and the controller communicatively coupled to the blade assembly and the translation mechanism. The method includes, in response to determining that the electronic device is in the idle state with the display off: determining a device state of the electronic device; and actuating the translation mechanism to translate the blade assembly to place a leading edge of the flexible display at a position that is indicative of the device state of the electronic device.

In one or more embodiments, a computer program product is provided for execution within an electronic device that includes a device housing, a blade assembly carrying a blade and a flexible display and slidably coupled to the device housing, a translation mechanism operable to slide the blade assembly in a plurality of positions relative to the device housing between an extended position and a retracted position, and a controller communicatively coupled to the blade assembly and the translation mechanism. The computer program product includes a non-transitory computer readable medium having program instructions that when executed by a processor of the electronic device, configures the electronic device to perform functions comprising: determining that the electronic device is in an idle state in which a display of the electronic device is off; and in response to determining that the electronic device is in the idle state with the display off: determining a device state of the electronic device; and actuating the translation mechanism to translate the blade assembly to place a leading edge of the flexible display at a position that is indicative of the device state of the electronic device.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined by the appended claims and equivalents thereof. Within the descriptions of the different views of the figures, similar elements are provided similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

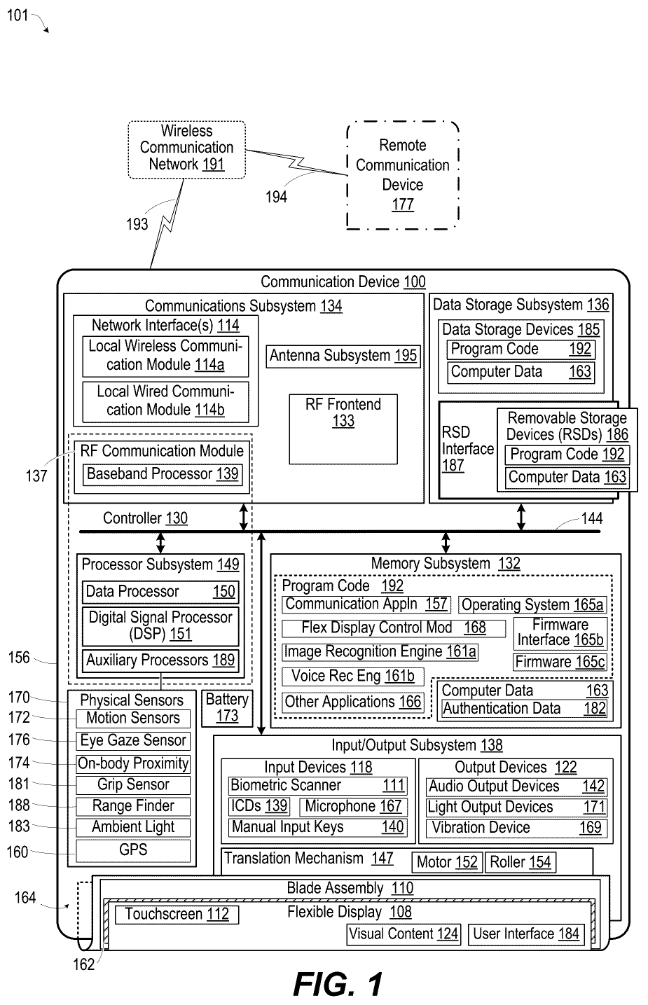

FIG. 1 is a functional block diagram depicting functional components of a communication device 100 within a communication environment 101 by which additional features, such as wireless communication, of the present disclosure are advantageously implemented. Communication device 100 can be one of a host of different types of devices, including but not limited to, a mobile cellular phone, satellite phone, or smart phone, a laptop, a netbook, an ultra-book, a wearable computing device, and/or a tablet computing device or similar device that can include wireless communication functionality. As a device supporting wireless communication, communication device 100 can be utilized as, and also be referred to as, a system, device, subscriber unit, subscriber station, mobile station (MS), mobile, mobile device, remote station, remote terminal, user terminal, terminal, user agent, user device, a Session Initiation Protocol (SIP) phone, a wireless local loop (WLL) station, a personal digital assistant (PDA), computer workstation, a handheld device having wireless connection capability, a computing device, or other processing devices connected to a wireless modem.

In one or more embodiments, functional components of communication device 100 include controller 130, memory subsystem 132, communications subsystem 134, data storage subsystem 136, and input/output (I/O) subsystem 138. I/O subsystem 138 includes I/O devices such as flexible display 108. According to aspects of the present disclosure, controller 130 is communicatively coupled to translation mechanism 147, which includes motor 152 and roller 154. Translation mechanism 147 is operable to slide blade assembly 110 relative to device housing 156 of communication device 100 between a retracted position as depicted at 158 and an at least partially extended position as depicted at 160. Blade assembly 110 carries blade 162, which is moved by roller 154, to position the flexible display 108 between a fully retracted position and an extended position, up to a fully extended position. Device housing 156 has front side 164 for viewing a portion of flexible display 108.

Referring now to the additional specific component makeup and the associated functionality of the presented components, system interlink 144 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components. In one or more embodiments, internal battery 173 provides power for operation of the components within communication device 100. In one or more embodiments, internal battery 173 may be recharged via one or more interfaces provided by input/output subsystem 138, including, but not limited to, a wired charging interface such as a USB-C interface, and/or a wireless charging interface. Although certain direct interconnections (i.e., system interlink 144) are illustrated in FIG. 1, it is to be understood that more, fewer, or different interconnections may be present in other embodiments.

In one or more embodiments, communications subsystem 134 may include one or more network interfaces 114, such as local wireless communication module 114a and local wired communication module 114b, to communicatively couple communication device 100 respectively via wireless connection 193 to wireless communication network 191.

Communications subsystem 134 includes antenna subsystem 195. Communications subsystem 134 includes radio frequency (RF) frontend 133 and RF communication module 137 having baseband processor 139. RF frontend 133 includes transceiver(s), receiver(s), and/or modem(s), to facilitate communication between connected devices on various computer networks.

In one or more embodiments, controller 130, via communications subsystem 134, performs wireless communication with wireless communication network 191. Communications subsystem 134 can communicate with remote communication device 177 via wireless connection 194 to wireless communication network 191. In one or more embodiments, remote communication device 177 can include a smartphone, tablet computer, smartwatch, wearable computer, laptop computer, desktop computer, and so on. In one or more embodiments, communication device 100 utilizes one or more IEEE 802.11 WLAN protocols. In one or more embodiments, communications subsystem 134 receives information from satellites to obtain geospatial location information for processing by GPS module 160.

Controller 130 includes processor subsystem 149, which includes one or more central processing units (CPUs), depicted as data processor 150. Processor subsystem 149 can include one or more digital signal processors 151 that can be integrated with data processor 150. Processor subsystem 149 can include other processors that are communicatively coupled to data processor 150, such as baseband processors 139 of communication module 137. In another example, auxiliary processors 189 may act as a low power consumption, always-on sensor hub for physical sensors 170. In one or more embodiments that are not depicted, controller 130 can further include distributed processing and control components that are external to housing 156 or grouped with other components, such as I/O subsystem 138. Data processor 150 is communicatively coupled, via system interlink 144, to memory subsystem 132. In one or more embodiments, data processor 150 is communicatively coupled via system interlink 144 to communications subsystem 134, data storage subsystem 136 and I/O subsystem 138. Controller 130 manages, and in some instances directly controls, the various functions and/or operations of communication device 100. These functions and/or operations include, but are not limited to including, application data processing, communication with second communication devices, navigation tasks, image processing, and signal processing. In one or more alternate embodiments, communication device 100 may use hardware component equivalents for application data processing and signal processing. For example, communication device 100 may use special purpose hardware, dedicated processors, general purpose computers, microprocessor-based computers, micro-controllers, optical computers, analog computers, dedicated processors and/or dedicated hard-wired logic.

Memory subsystem 132 stores program code 192 for execution by processor subsystem 149 to provide the functionality described herein. Program code 192 includes applications such as communication application 157 that receives or generates visual content 124 on touchscreen 112 for implementations of user interface 184. Program code 192 can include various functions, including, but not limited to, flexible display control module 168 that may be software or firmware that controls the position of blade assembly 110 in response to determining that the device 100 is in an idle state, and then positioning the blade assembly to be indicative of a device state such as device volume, battery charge level, new message status, network mode, and/or other device states, in accordance with one or more embodiments. Program code 192 may include applications or utilities, such as image recognition engine 161a and voice recognition engine 161b, and other applications 166. In one or more embodiments, several of the described aspects of the present disclosure are provided via executable program code of applications executed by controller 130. In one or more embodiments, program code 192 may be integrated into a distinct chipset or hardware module as firmware that operates separately from executable program code. Portions of program code 192 may be incorporated into different hardware components that operate in a distributed or collaborative manner. Implementation of program code 192 may use any known mechanism or process for doing so using integrated hardware and/or software, as known by those skilled in the art. Program code 192 may access, use, generate, modify, store, or communicate computer data 163, such as authentication data 182. Computer data 163 may be organized in one of a number of different data structures. Common examples of computer data 163 include video, graphics, text, and images as discussed herein. Computer data 163 can also be in other forms of flat files, databases, and other data structures.

Memory subsystem 132 further includes operating system (OS) 165a, firmware interface 165b, such as basic input/output system (BIOS) or Uniform Extensible Firmware Interface (UEFI), and firmware 165c, which may be considered to be program code 192.

I/O subsystem 138 includes input devices 118, output devices 122, and I/O devices, such as flexible display 108. Flexible display 108 includes touchscreen 112 that operates as a user interface 184 of communication device 100. Blade assembly 110 includes blade 162 which supports flexible display 108. Input devices 118 may include biometric scanner 111, image capturing devices (ICDs) 139, manual input devices 140 (e.g., keys and buttons), microphone 167. In one or more embodiments, biometric scanner 111 can include a fingerprint scanner and/or a palmprint scanner. Output devices 122 may include audio output devices 142, light output devices 171, and vibration device 169.

Physical sensors 170 provides additional contextual indications of the use and environment of communication device 100. Examples of physical sensors 170 include motion sensors 172 which can include one or more motion detectors such as accelerometers that detect when communication device 100 is being moved by a user, or is stationary on a surface, such as table. Physical sensors 170 may include eye gaze sensor 176 that detects whether a user is looking toward communication device 100. Physical sensors 170 may include on-body proximity sensors 174 that detects proximity to a lossy dielectric mass (i.e., a hand or body of a user), such as when communication device 100 is placed in a pocket. Physical sensors 170 may include grip sensors 181 exteriorly presented on housing 156 detecting when communication device 100 is being held in a hand of a user. Physical sensors 170 may include range finder 188 and ambient light sensor 183. In one or more embodiments, controller 130 automatically responds to changes in device state, by positioning blade assembly 110 of communication device 100 in one configuration from among a fully retracted position, a fully extended position, and/or at least one intermediate position, where the position is indicative of a current device state, enabling a current device state to be conveyed while the display is off.

Data storage subsystem 136 of communication device 100 includes data storage device(s) 185. Controller 130 is communicatively connected, via system interlink 144, to data storage device(s) 185. Data storage subsystem 136 provides program code 192 and computer data 163 stored on nonvolatile storage that is accessible by controller 130. For example, data storage subsystem 136 can provide a selection of program code 192 and computer data 163. These applications can be loaded into memory subsystem 132 for execution/processing by controller 130. In one or more embodiments, data storage device(s) 185 can include hard disk drives (HDDs), optical disk drives, and/or solid-state drives (SSDs), etc. Data storage subsystem 136 of communication device 100 can include removable storage device(s) (RSD(s)) 186, which is received in RSD interface 187. Controller 130 is communicatively connected to RSD 186, via system interlink 144 and RSD interface 187. In one or more embodiments, RSD 186 is a non-transitory computer program product or computer readable storage device. Controller 130 can access data storage device(s) 185 or RSD 186 to provision communication device 100 with program code 192.

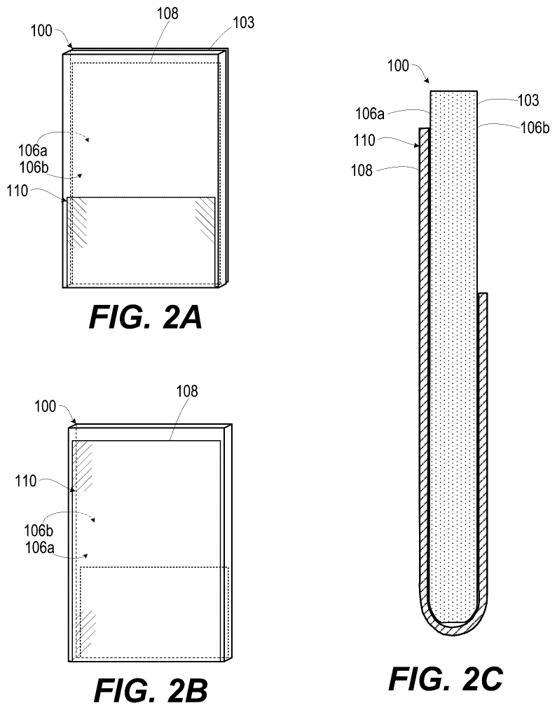

FIG. 2A depicts a back view of an example communication device having a translating blade assembly with flexible display moved to a fully retracted sliding position where the blade assembly wraps around a back surface of the device housing of the communication device, according to one or more embodiments. FIG. 2B depicts a front view of the example communication device of FIG. 2A with a front portion of the blade assembly not extending beyond the device housing, according to one or more embodiments. FIG. 2C depicts a side view of the example communication device of FIG. 2A with the front portion of the blade assembly not extending beyond the device housing, according to one or more embodiments. With reference to FIGS. 1 and 2A-2C, when communication device 100 is in a retracted configuration, more of blade assembly 110, along with flexible display 108, rolls around one end of device housing 103, retracted onto back side 106b of device housing 103 so that an opposite end of blade assembly 110 does not extend beyond front side 106a of device housing 103.

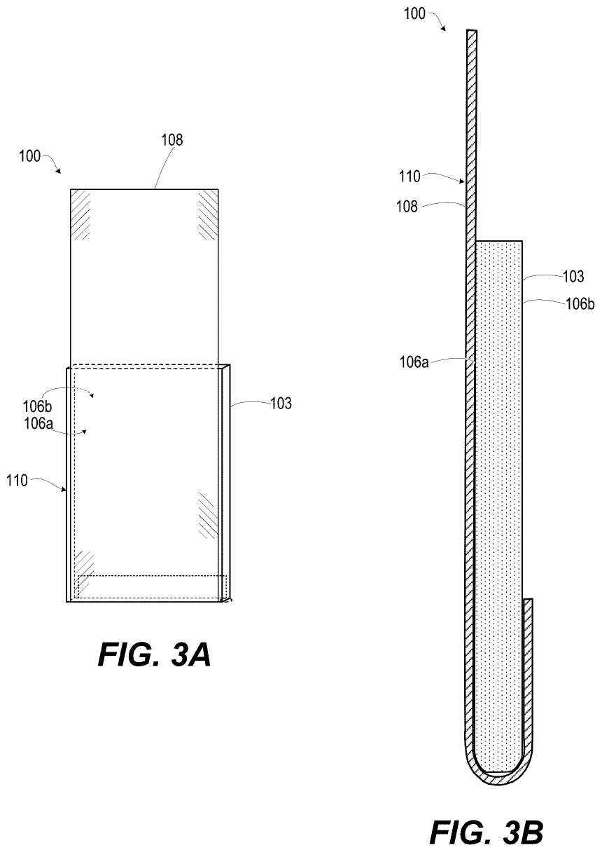

FIG. 3A is a front view of communication device 100 having blade assembly 110 moved to a fully extended sliding position. FIG. 3B depicts a left side view of communication device 100 of FIG. 3A. With reference to FIGS. 1 and 3A-3B, when communication device 100 is in an extended configuration, blade assembly 110 extends beyond an edge opposite to a rolling edge of front side 106a of device housing 103, increasing a display area of flexible display 108 on front side 106a. As depicted, blade assembly 110 extends upward.

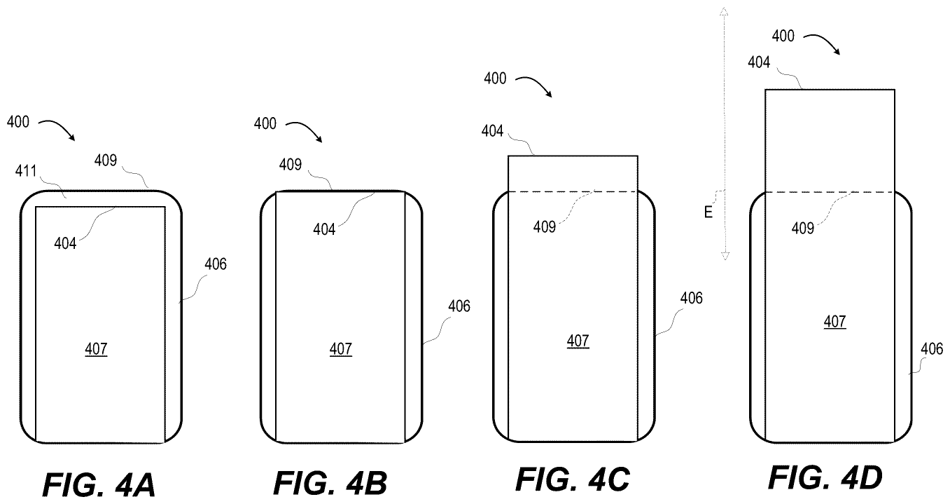

FIG. 4A depicts a front view of an example communication device 400 having the display 407 in a fully retracted position, such that a leading edge 404 of the display 407 is below a top edge 409 of the device housing 406, exposing an upper area 411 on the front side of the device housing 406, according to one or more embodiments. Device 400 may be an implementation of communication device 100 (FIG. 1) having the same or similar components and providing the same or similar functions as communication device 100. FIG. 4B depicts a front view of the example communication device of FIG. 4A with the display 407 in a partially extended position such that a leading edge 409 of the display 407 is/appears flush with a top edge of the device housing, according to one or more embodiments. FIG. 4C depicts a front view of the example communication device of FIG. 4A with the blade assembly in a partially extended position such that a leading edge 404 of the display 407 extends beyond a top edge of the device housing, according to one or more embodiments. FIG. 4D depicts a front view of the example communication device of FIG. 4A with the display 407 in a fully extended position such that a leading edge 404 of the display 407 extends further beyond a top edge of the device housing than as shown in FIG. 4C, according to one or more embodiments.

In comparing the configurations shown in FIG. 4A-FIG. 4D, it can be seen that each configuration provides an easily observable difference that can convey device state information in accordance with one or more embodiments. As an example, the position of display 407 shown in FIG. 4A can signify an incoming call notification mode of silent (i.e., the device does not produce sound or vibration in response to an incoming call), the position of display 407 shown in FIG. 4B can signify an incoming call notification mode of vibrate only, the position of display 407 shown in FIG. 4C can signify an incoming call notification mode of a low volume level, and the position of display 407 shown in FIG. 4D can signify an incoming call notification mode of a high volume level. Accordingly, the configurations shown in FIG. 4A-FIG. 4D enable a user to determine an incoming call notification mode based on the position of the display 407, thereby conveying device state information without utilizing any electric power from an internal battery to present content on the display.

In another example, the position of display 407 shown in FIG. 4A can signify a battery charge level of 25 percent or less, the position of display 407 shown in FIG. 4B can signify a battery charge level ranging from 26 percent to 50 percent, the position of display 407 shown in FIG. 4C can signify a battery charge level ranging from 51 percent to 75 percent, and the position of display 407 shown in FIG. 4D can signify a battery charge level greater than 75 percent. Accordingly, the configurations shown in FIG. 4A-FIG. 4D enable a user to determine a battery charge level based on the position of the display 407, thereby conveying battery charge level information without utilizing any electric power from an internal battery to visually present battery charge level information on the display. In one or more embodiments, only three positions of the display 407 may be used, signifying a battery charge level that includes a low level, a medium level, and a high level. The aforementioned percentage levels are exemplary, and other embodiments may use more, fewer, and/or different percentage levels to correspond to a given position of the flexible display.

In another example, the position of display 407 shown in FIG. 4A can signify a new message status of no, meaning no new messages have been received, and the position of display 407 shown in FIG. 4B can signify a new message status of yes, indicating that at least one new message has been received since the previous occurrence where the user read or accessed messages. Accordingly, the configurations shown in FIG. 4A and FIG. 4B can enable a user to determine if a new message has been received by the electronic device, thereby conveying new message status information without utilizing any electric power from an internal battery to present a new message notification on the display.

In another example, the position of display 407 shown in FIG. 4A can signify a network mode of no connection (null value), the position of display 407 shown in FIG. 4B can signify a network mode of WIFI connection, and the position of display 407 shown in FIG. 4C can signify a network mode of cellular connection. Accordingly, the configurations shown in FIG. 4A-FIG. 4C enable a user to determine a network mode based on the position of the display 407, thereby conveying network mode information without utilizing any electric power from an internal battery to present connectivity information on the display.

In one or more embodiments, as shown in FIG. 4A-FIG. 4D, to actuate the translation mechanism to translate the blade assembly to place the leading edge of the flexible display at the position indicative of the device state of the electronic device, the controller translates the blade assembly along an elongated axis of the electronic device. The elongated axis is indicated as E in FIG. 4D.

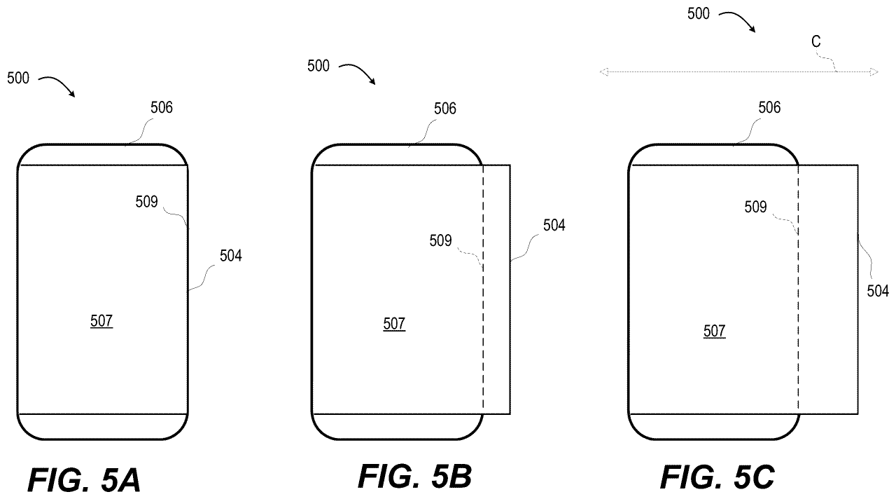

FIG. 5A depicts a front view of another example communication device 500 having a laterally-translating blade assembly with display 507 that extends along a crosswise axis of the communication device and is shown in a fully retracted position such that a leading edge 504 of the display 507 is flush with lateral edge 509 of the device housing 506, according to one or more embodiments. Device 500 may be an implementation of communication device 100 (FIG. 1) having the same or similar components and providing the same or similar functions as communication device 100. FIG. 5B depicts a front view of the example communication device of FIG. 5A with the display 507 in a partially extended position such that a leading edge 504 of the display 507 extends beyond lateral edge 509 of the device housing 506, according to one or more embodiments. FIG. 5C depicts a front view of the example communication device of FIG. 5A with the display 507 in a fully extended position such that leading edge 504 of the display 507 extends further beyond lateral edge 509 of the device housing 506 than as shown in FIG. 5B, according to one or more embodiments.

In comparing the configurations shown in FIG. 5A-FIG. 5C, it can be seen that each configuration provides an easily observable difference that can convey device state information in accordance with one or more embodiments. As an example, the position of display 507 shown in FIG. 5A can signify an incoming call notification mode of silent, the position of display 507 shown in FIG. 5B can signify an incoming call notification mode of vibrate only, and the position of display 507 shown in FIG. 5C can signify an audible incoming call notification mode (i.e., the ringer is on). While three positions are indicated in FIG. 5A-FIG. 5C, embodiments utilizing a display that extends along a crosswise axis of the communication device can provide more or fewer positions for conveying device state information while the display is off.

In one example, the position of display 507 shown in FIG. 5A can signify a battery charge level of 33 percent or less (low level), the position of display 507 shown in FIG. 5B can signify a battery charge level ranging from 34 percent to 66 percent (medium level), and the position of display 507 shown in FIG. 5C can signify a battery charge level greater than 66 percent (high level). Accordingly, the configurations shown in FIG. 5A-FIG. 5C enable a user to determine a battery charge level based on the position of the display 407, thereby conveying device state information without utilizing any electric power from an internal battery to present that information as visible content on the display. In one or more embodiments, three positions of the display 507, as depicted in FIG. 5A-FIG. 5C may be used, signifying a battery charge level that includes a low level, a medium level, and a high level.

In another example, the position of display 507 shown in FIG. 5A can signify a new message status of no, and the position of display 507 shown in FIG. 5B can signify a new message status of yes. Accordingly, the configurations shown in FIG. 5A and FIG. 5B can enable a user to determine if a new message has been received by the electronic device, thereby conveying new message status information without utilizing any electric power from an internal battery to present that information as visible content on the display.

In another example, the position of display 507 shown in FIG. 5A can signify a network mode of no connection, the position of display 507 shown in FIG. 5B can signify a network mode of WIFI connection, and the position of display 507 shown in FIG. 5C can signify a network mode of cellular connection. Accordingly, the configurations shown in FIG. 5A-FIG. 5C enable a user to determine a network mode based on the position of the display 507, thereby conveying network mode information without utilizing any electric power from an internal battery to present that information as visible content on the display.

In one or more embodiments, as shown in FIG. 5A-FIG. 5C, to actuate the translation mechanism to translate the blade assembly to place a leading edge of the flexible display at the position indicative of the device state of the electronic device, the controller translates the blade assembly along a crosswise axis of the electronic device. The crosswise axis is indicated as C in FIG. 5C.

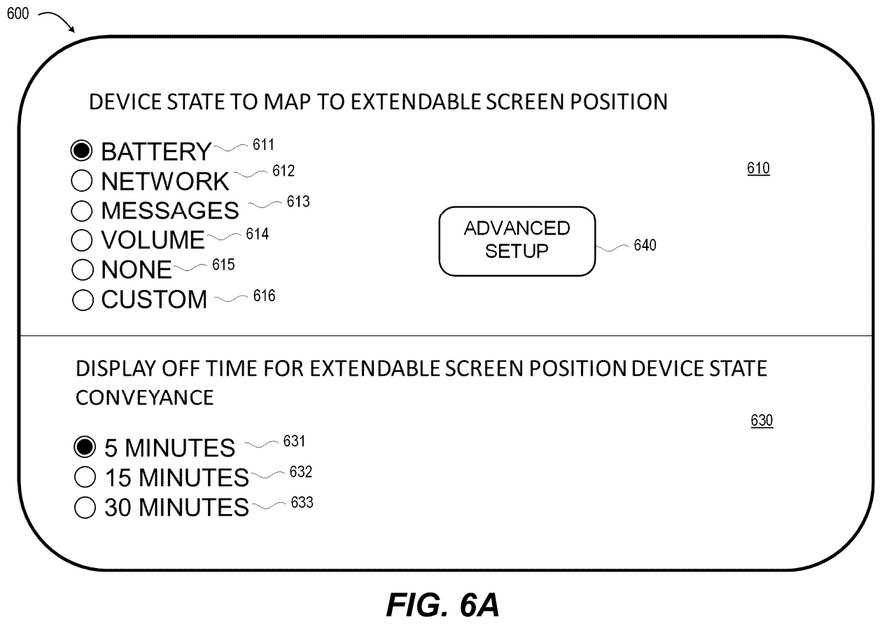

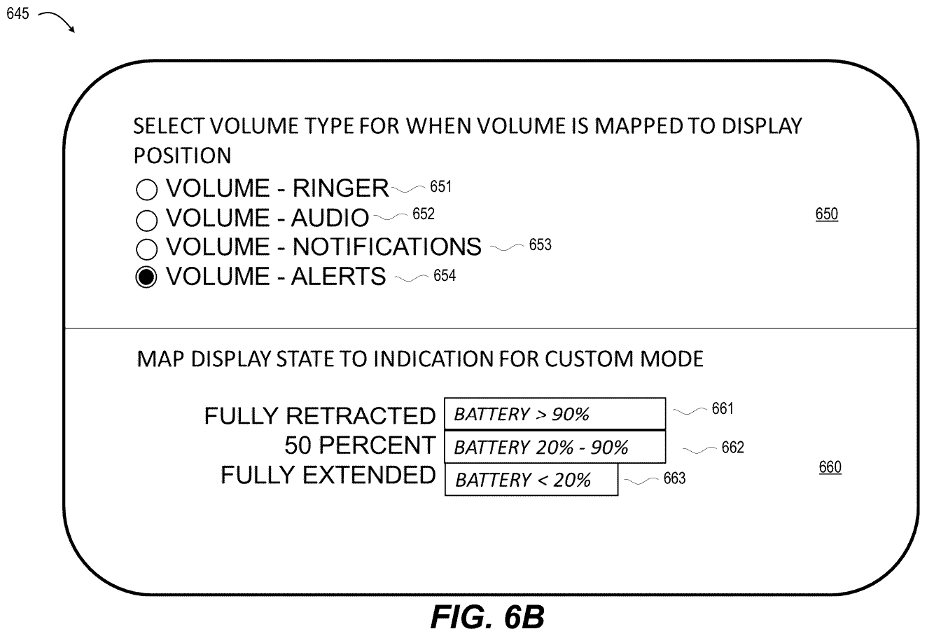

FIG. 6A depicts an exemplary user interface 600 for configuring various options to convey a state of an electronic device while the display is off by using different positions of the extendable display screen, according to one or more embodiments. In one or more embodiments, the user interface 600 includes a mapping section 610, and a time section 630. The mapping section 610 enables a user to select a given device state to associate with a display position. Option 611, which is shown as selected, associates a battery charge level with an extendable screen (display) position. Option 612, when selected, associates a network mode with an extendable screen (display) position. Option 613, when selected, associates a new message status with an extendable screen (display) position. In one or more embodiments, the new message status can be associated with text messages, email messages, and/or application messages (e.g., social media messages). In one or more embodiments, the user interface 600 may provide additional controls to allow a user to specify which type(s) of messages are associated with the new message status. Option 614, when selected, associates a device volume with an extendable screen (display) position. The device volume can include a ringer volume, incoming call notification mode, speaker volume, and so on. The advanced setup button 640 invokes an additional user interface to allow a user to specify which volume type is associated with an extendable screen (display) position. Option 615, when selected, disables the feature, such that no device state is associated with an extendable screen (display) position. This setting can also be a default setting such that no user selection is required. Option 616, when selected, enabled a custom association between a device state and an extendable screen (display) position that the user can define. The advanced setup button 640 invokes a user interface to enable the user to customize the behavior accordingly when the custom option 616 is selected.

The time section 630 enables a user to specify a duration for which the communication device is idle, before the extendable screen (display) position is moved (when one of options 611-614 or 616 is selected). In one or more embodiments, a device is considered as idle when the display is off and the device has been stationary for a predetermined amount of time. In one or more embodiments, the determination of being stationary may be accomplished, at least in part, by utilizing motion sensors 172 (FIG. 1). Option 631, shown as selected via a radio button, configures the device to enable setting an extendable screen (display) position associated with a device state upon five minutes of idle time. Option 632, when selected, configures the device to enable setting an extendable screen (display) position associated with a device state upon 15 minutes of idle time. Option 633, when selected, configures the device to enable setting an extendable screen (display) position associated with a device state upon 30 minutes of idle time. While time section 630 shows three choices, other embodiments may include more or fewer choices, or provide a numeric field for a user to enter a number of minutes of idle time before the extendable screen (display) position is moved (when one of options 611-614 or 616 is selected). In one or more embodiments, the display is moved only when the idle time limit is reached and the display is off. In one or more embodiments, the display is moved to the specific position whenever the display turns off, without requiring the user to select a specific time limit.

FIG. 6B depicts exemplary advanced setup options user interface 645, according to one or more embodiments. Section 650 enables specifying which type of volume is associated with an extendable screen (display) position when the volume option (614 of FIG. 6A) is selected. Option 651 corresponds to a ringer volume for incoming calls. Option 652 corresponds to audio volume for voice and/or media playback. Option 653 corresponds to notifications, such as from applications. Option 654 corresponds to alerts, such as from alarms, and so on. The volume options shown in in FIG. 6B are exemplary, and other volume options are possible in disclosed embodiments.

Section 660 enables specifying a custom behavior that is associated with an extendable screen (display) position when the custom option (616 of FIG. 6A) is selected. As shown in FIG. 6B, a fully retracted display position is associated with a battery charge level that exceeds 90 percent, as shown in field 661. A display position of 50 percent (extended halfway) is associated with a battery charge level that is in the range of 20 percent to 90 percent, as shown in field 662. A display position of fully extended is associated with a battery charge level that is in the range of less than 20 percent, as shown in field 663. The associations shown in section 660 are exemplary, and other user-defined associations are possible in disclosed embodiments, thereby enabling a user to customize the meanings of various display positions as he/she chooses.

In one or more embodiments, to determine the device state of the electronic device, the controller determines a device volume that includes an incoming call notification mode of the electronic device, where the incoming call notification mode includes at least one of a silent setting, a vibrate setting, and at least one volume setting. The controller actuates the translation mechanism to translate the blade assembly to place the leading edge of the flexible display at a position indicative of a current value of the incoming call notification mode.

In one or more embodiments, to determine the device state of the electronic device, the controller determines a battery charge level for an internal battery of the electronic device, where the battery charge level includes a low level, a medium level, and a high level. The controller actuates the translation mechanism to translate the blade assembly to place the leading edge of the flexible display at a position indicative of a current battery charge level of the battery.

In one or more embodiments, to determine the device state of the electronic device, the controller determines a network mode of the electronic device, where the network mode includes a connection type value identifying one of a WIFI connection, a cellular connection, and no connection. The controller actuates the translation mechanism to translate the blade assembly to place the leading edge of the flexible display at a position indicative of a current connection type value of the network mode.

In one or more embodiments, to determine the device state of the electronic device, the controller determines a new message status of the electronic device, where the new message status includes one of a value of no and a value of yes. The controller actuates the translation mechanism to translate the blade assembly to place the leading edge of the flexible display at a position indicative of a current value of the new message status.

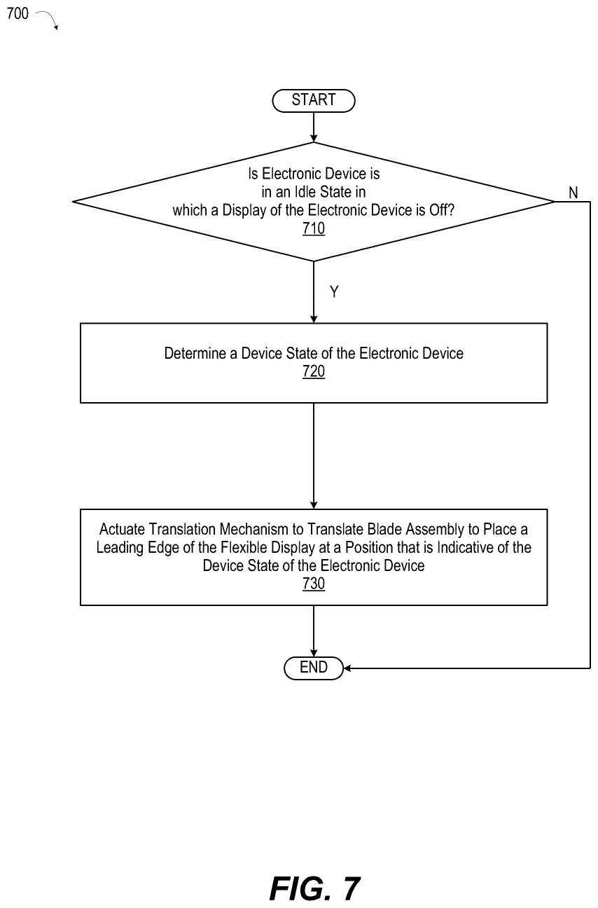

Referring now to the flowchart, FIG. 7 depicts a flowchart of a method 700 by which an electronic device enables conveyance of a device state, while the display is off, based on a position of an extendable screen (display), according to one or more embodiments. The descriptions of methods in FIG. 7 are provided with general reference to the specific components illustrated within the preceding FIGS. 1-6. Specific components referenced in FIG. 7 may be identical or similar to components of the same name used in describing preceding FIGS. 1-6. In one or more embodiments, controller 130 (FIG. 1) configures communication device 100 (FIG. 1) to provide the described functionality of the method depicted in FIG. 7 by executing program code for one or more modules or applications provided within memory subsystem 132 of communication device 100.

FIG. 7 is a flow diagram presenting a method 700 of conveying a state of an electronic device while the display is off, according to one or more embodiments. The method starts at block 710 where a check is made to determine if the device is in an idle state, in which a display of the electronic device is off. The idle state can include a determination that the device is stationary, as determined at least in part, by motion sensors 172 (FIG. 1). The motion sensors 172 can include one or more accelerometers, gyroscopes, and/or other motion sensors. If, at block 710, the electronic device is not in an idle state, or the display of the electronic device is on, the method ends. If, at block 710, it is determined that the electronic device is in an idle state and the display is off, the method 700 continues to block 720, in which a current device state of the electronic device is determined. In one or more embodiments, this determination can be based on the user-configured setting in the mapping section 610 of user interface 600 (FIG. 6A). The determination can include determining an incoming call notification mode. Additionally, as an example, if option 611 is selected in FIG. 6A, then determining the device state includes determining a battery charge level. Similarly, if option 612 is selected in FIG. 6A, then determining the device state includes determining a network mode, and if option 613 is selected in FIG. 6A, then determining the device state includes determining a new message status.

The method 700 then continues to block 730, where the translation mechanism is actuated to translate a blade assembly to place a leading edge of a flexible display (extendable screen) at a position that is indicative of the device state of the electronic device. Examples of these positions are shown in at least FIG. 4A-FIG. 4D, and FIG. 5A-FIG. 5C. In one or more embodiments, the translation of the blade assembly, and thus the flexible display, is performed, at least in part, utilizing translation mechanism 147, motor 152, roller 154, blade assembly 110, and/or flexible display 108, shown in FIG. 1. In one or more embodiments, the translation mechanism 147 may include one or more positional encoders, stepper motors, servo motors, and/or other components and/or circuitry to enable moving and tracking the position of the flexible display 108.

As can now be appreciated, disclosed embodiments provide a visual affordance via a rollable device for determining a device state while the device is in an idle state with the display off. Disclosed embodiments alleviate the need for a user to turn on a display to check a device status such as a new message status, network mode, battery charge level, and/or other device states. In this way, disclosed embodiments enable a user to determine important device information without needing to physically contact the device or turn on the display of the device. By enabling the conveyance of device status without the need to turn on the display, battery charge level can be conserved, thereby improving the operational time before recharging of the battery is needed.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an crasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a device housing;
a blade assembly carrying a blade and a flexible display and slidably coupled to the device housing;
a translation mechanism operable to slide the blade assembly in a plurality of positions relative to the device housing between an extended position and a retracted position; and
a controller communicatively coupled to the blade assembly and the translation mechanism, and which:
determines whether the electronic device is in an idle state with the flexible display being off; and
in response to determining that the electronic device is in the idle state:
determines a device state of the electronic device; and
actuates the translation mechanism to translate the blade assembly to place a leading edge of the flexible display in a position indicative of the device state of the electronic device.

2. The electronic device of claim 1, wherein:
to determine the device state of the electronic device, the controller determines a device volume that includes an incoming call notification mode of the electronic device, wherein the incoming call notification mode comprises at least one of a silent setting, a vibrate setting, and at least one volume setting; and
the controller actuates the translation mechanism to translate the blade assembly to place the leading edge of the flexible display at a position indicative of a current value of the incoming call notification mode.

3. The electronic device of claim 1, wherein:
to determine the device state of the electronic device, the controller determines a battery charge level for an internal battery of the electronic device, wherein the battery charge level comprises a low level, a medium level, and a high level; and
the controller actuates the translation mechanism to translate the blade assembly to place the leading edge of the flexible display at a position indicative of a current battery charge level of the internal battery.

4. The electronic device of claim 1, wherein:
to determine the device state of the electronic device, the controller determines a network mode of the electronic device, wherein the network mode comprises a connection type value identifying one of a WIFI connection, a cellular connection, and no connection; and
the controller actuates the translation mechanism to translate the blade assembly to place the leading edge of the flexible display at a position indicative of a current connection type value of the network mode.

5. The electronic device of claim 1, wherein:
to determine the device state of the electronic device, the controller determines a new message status of the electronic device, wherein the new message status comprises one of a value of yes and a value of no; and
the controller actuates the translation mechanism to translate the blade assembly to place the leading edge of the flexible display at a position indicative of a current value of the new message status.

6. The electronic device of claim 1, wherein to actuate the translation mechanism to translate the blade assembly to place the leading edge of the flexible display at the position indicative of the device state of the electronic device, the controller translates the blade assembly along an elongated axis of the electronic device.

7. The electronic device of claim 1, wherein to actuate the translation mechanism to translate the blade assembly to place a leading edge of the flexible display at the position indicative of the device state of the electronic device, the controller translates the blade assembly along a crosswise axis of the electronic device.

8. A method comprising:
determining, by a controller of an electronic device, that the electronic device is in an idle state in which a display of the electronic device is off, wherein the electronic device comprises a device housing, a blade assembly carrying a blade and a flexible display and slidably coupled to the device housing, a translation mechanism operable to slide the blade assembly relative to the device housing to a plurality of positions between an extended position and a retracted position, and the controller communicatively coupled to the blade assembly and the translation mechanism;
in response to determining that the electronic device is in the idle state with the display off:
determining a device state of the electronic device; and
actuating the translation mechanism to translate the blade assembly to place a leading edge of the flexible display at a position that is indicative of the device state of the electronic device.

9. The method of claim 8, wherein:
determining the device state further comprises determining a device volume that includes an incoming call notification mode of the electronic device from among at least one of a silent setting, a vibrate setting, and at least one volume setting; and
actuating the translation mechanism comprises translating the blade assembly to place the leading edge of the flexible display at a position indicative of a current value of the incoming call notification mode.

10. The method of claim 8, wherein:
determining the device state further comprises determining a battery charge level for a battery internal to the electronic device from among a low level, a medium level, and a high level; and
actuating the translation mechanism comprises translating the blade assembly to place the leading edge of the flexible display at a position indicative of a current battery charge level of the battery.

11. The method of claim 8, wherein:
determining the device state further comprises determining a network mode of the electronic device, wherein the network mode comprises a connection type value identifying one of a WIFI value, a cellular value, and a null value; and
actuating the translation mechanism to translate the blade assembly to place the leading edge of the flexible display at a position indicative of a current connection type value of the network mode.

12. The method of claim 8, wherein:
determining the device state further comprises determining a new message status of the electronic device, wherein the new message status comprises one of a value of yes, and a value of no, and
actuating the translation mechanism to translate the blade assembly to place the leading edge of the flexible display at a position indicative of a current value of the new message status.

13. The method of claim 8, wherein actuating the translation mechanism to translate the blade assembly to place the leading edge of the flexible display at a position indicative of the device state of the electronic device comprises translating the blade assembly along an elongated axis of the electronic device.

14. The method of claim 8, wherein actuating the translation mechanism to translate the blade assembly to place the leading edge of the flexible display at a position indicative of the device state of the electronic device comprises translating the blade assembly along a crosswise axis of the electronic device.

15. A computer program product comprising a non-transitory computer readable medium having program instructions that when executed by a processor of an electronic device that comprises a device housing, a blade assembly carrying a blade and a flexible display and slidably coupled to the device housing, a translation mechanism operable to slide the blade assembly in a plurality of positions relative to the device housing between an extended position and a retracted position, and a controller communicatively coupled to the blade assembly and the translation mechanism, configures the electronic device to perform functions comprising:
determining that the electronic device is in an idle state in which a display of the electronic device is off; and
in response to determining that the electronic device is in the idle state with the display off:
determining a device state of the electronic device; and
actuating the translation mechanism to translate the blade assembly to place a leading edge of the flexible display at a position that is indicative of the device state of the electronic device.

16. The computer program product of claim 15, wherein the computer program product further comprises program instructions for:
determining the device state, including determining a device volume that includes an incoming call notification mode of the electronic device from among at least one of a silent setting, a vibrate setting, and at least one volume setting; and
actuating the translation mechanism comprises translating the blade assembly to place the leading edge of the flexible display at a position indicative of a current value of the incoming call notification mode.

17. The computer program product of claim 15, wherein the computer program product further comprises program instructions for:
determining the device state, including determining a battery charge level for a battery internal to the electronic device from among a low level, a medium level, and a high level; and
actuating the translation mechanism comprises translating the blade assembly to place the leading edge of the flexible display at a position indicative of a current battery charge level of the battery.

18. The computer program product of claim 15, wherein the computer program product further comprises program instructions for:
determining the device state, including determining a network mode of the electronic device, wherein the network mode comprises a connection type value identifying one of a WIFI value, a cellular value, and a null value; and
actuating the translation mechanism to translate the blade assembly to place the leading edge of the flexible display at a position indicative of a current connection type value of the network mode.

19. The computer program product of claim 15, wherein the computer program product further comprises program instructions for:
determining the device state, including determining a new message status of the electronic device, wherein the new message status comprises one of a value of yes, and a value of no, and
actuating the translation mechanism to translate the blade assembly to place the leading edge of the flexible display at a position indicative of a current value of the new message status.

20. The computer program product of claim 15, wherein the computer program product further comprises program instructions for actuating the translation mechanism to translate the blade assembly to place the leading edge of the flexible display at a position indicative of the device state of the electronic device by translating the blade assembly along an elongated axis of the electronic device.
